(19) United States
(12) Patent Application Publication
(10) Pub. No.: US 2021/0278855 A1
(43) Pub. Date: Sep. 9, 2021

(54) AUTONOMOUS VEHICLE

(71) Applicant: MURATA MACHINERY, LTD., Kyoto-shi (JP)

(72) Inventor: Tsukasa SAKAI, Kyoto (JP)

(21) Appl. No.: 17/183,409

(22) Filed: Feb. 24, 2021

(30) Foreign Application Priority Data
Mar. 5, 2020 (JP) 2020-038025
Dec. 24, 2020 (JP) 2020-214845

(51) Int. Cl. G05D 1/02; G05D 1/00

(52) U.S. Cl. CPC G05D 1/0221; A63B 57/00; G05D 1/0088; G05D 1/0274

(57) ABSTRACT

An autonomous vehicle executes a teaching travel mode to store a route traveled by an operator's manual operation and an autonomous travel mode to autonomously travel on a planned traveling route. A ball collection route travel schedule creator creates a planned traveling route from a teaching route obtained by the teaching travel mode. A difference calculator calculates differences in position coordinates and posture angles between an arbitrary point designated by an operator and a current position. A display displays the differences calculated by the difference calculator.

### CROSS REFERENCE TO RELATED APPLICATIONS

This application claims the benefit of priority under 35 U.S.C. 119 to Japanese Patent Application No. 2020-038025 filed on Mar. 5, 2020 and Japanese Patent Application No. 2020-214845 filed on Dec. 24, 2020. The entire contents of each of these applications are hereby incorporated herein by reference.

### BACKGROUND OF THE INVENTION

### 1. Field of the Invention

The present invention relates to an autonomous vehicle.

### 2. Description of the Related Art

An autonomous vehicle travels autonomously according to a route plan from a travel start position to a travel end position. The autonomous vehicle is used for a device that is required to travel evenly in a specific area, such as a cleaning robot or a ball collecting/ejecting machine in a golf driving range.

In the case of a cleaning robot or a ball collecting/ejecting machine, the autonomous vehicle performs teaching reproduction travel. Teaching reproduction travel means that the autonomous vehicle travels on the basis of a traveling route taught by the operator in advance.

One type of teaching reproduction travel is copy travel in which all traveling routes are taught in advance by the operator's operation, and the autonomous vehicle reproduces the traveling routes as they are (see, U.S. 2016/0062361 A1, for example).

One type of teaching reproduction travel is fill travel, in which an outer circumference is taught by the operator's operation and the autonomous vehicle creates and executes a route plan to fill the inside of the outer circumference (see, U.S. 2019/0208978 A1, for example).

When teaching the outer circumference of filling, the operator operates the autonomous vehicle to teach. In the teaching, it is important to align a teaching start position and a teaching end position to close the outer circumference of the filling (the risk of hitting an obstacle increases if the positions are not aligned), and to create a square outer circumference for cleaning efficiency, for example. In order to observe the above precautions, the operator operates the autonomous vehicle manually while referring to surrounding walls and the terrain.

However, the operator does not have a way to confirm the teaching route or the current position while teaching the outer circumference for fill travel or teaching the route for copy travel. Additionally, in an open space such as a driving range, there is no mark in the surrounding environment, so it is difficult to travel in a straight line or grasp the sense of distance. For these reasons, it has been difficult for the operator to create a desired linear route or circular route accurately.

### SUMMARY OF THE INVENTION

According to preferred embodiments of the present invention, autonomous vehicles allow operators to create a desired straight route or a circular route accurately.

Hereinafter, multiple aspects of various preferred embodiments of the present invention will be described, and it should be understood that these aspects can be arbitrarily combined as needed or desired.

An autonomous vehicle according to one aspect of a preferred embodiment of the present invention executes a teaching travel mode to store a route traveled by an operator's manual operation and an autonomous travel mode to autonomously travel on a planned traveling route. The autonomous vehicle includes a planned traveling route creator, a current position estimator, a difference calculator, and a display.

The planned traveling route creator creates a planned traveling route from a teaching route obtained by the teaching travel mode.

The current position estimator estimates a current position of the autonomous vehicle.

The difference calculator calculates the difference in position coordinates and posture angle between an arbitrary point and current position as guide information to a travel destination point.

The display displays the above difference as guide information.

With this device, the operator can know the difference in the coordinates and posture angle of the autonomous vehicle between an arbitrary point and the current position. Accordingly, for example, by displaying the distance and the angle from an arbitrary point designated by the operator at the time of manual operation, the operator can create a desired straight route or circular route accurately.

The arbitrary point may be a teaching start point of the teaching travel mode, and the difference calculator may calculate, as the difference, a change amount of the position coordinates and the posture angle from the teaching start point to the current position during execution of the teaching travel mode.

With this device, since the above change amount is displayed on the display during execution of the teaching travel mode, a route returning to the teaching start point (e.g., an outer circumference route for filling with a closed outer circumference or a rectangular outer circumference route for filling) is easy to create.

Additionally, with this device, movement to a teaching start point becomes easy and accurate before execution of the teaching travel mode.

When the change amount of the position coordinates and the posture angle from the teaching start point to the current position falls below a predetermined value during execution of the teaching travel mode when teaching an outer circumference of a filling area, the display may display that an annular route can be created.

With this device, when the change amount falls below a predetermined value (i.e., when the autonomous vehicle is in a teaching start position), the display displays that a circular route can be created. Accordingly, the operator can surely know the fact that the autonomous vehicle is in a position where a circular route can be created. The display process described above is performed by an operator's display operation or automatically, for example.

If the change amount of the position coordinates and the posture angle from the teaching start point to the current position does not fall below a predetermined value at the end of the teaching during execution of the teaching travel mode when teaching an outer circumference of a filling area, the display may display warning information.

With this device, it is possible to prevent the operator from ending the teaching when the autonomous vehicle has not returned to the teaching start position.

The arbitrary point may be an autonomous travel start point, and the difference calculator may calculate the difference in the position coordinates and the posture angle between the current position and the autonomous travel start point before the autonomous travel.

With this device, since the difference between the current position and the autonomous travel start point is displayed, the operator can accurately know how the autonomous vehicle deviates from the autonomous travel start point before the start of the autonomous travel. As a result, the operator can move the autonomous vehicle smoothly to the autonomous travel start point when adjusting the position manually.

The display may display a notification that autonomous travel can be started when the difference in the position coordinates and the posture angle between the current position and the autonomous travel start point falls below a predetermined value.

With this device, since the notification that autonomous driving can be started is displayed as described above, the operator can quickly know that the autonomous vehicle has reached the autonomous travel start position when adjusting the position manually.

The arbitrary point may be a teaching end point of the teaching travel mode, and the difference calculator may calculate the difference in the position coordinates and the posture angle between the teaching end point and the current position during execution of the teaching travel mode.

As a result, with this autonomous vehicle, the operator can move the autonomous vehicle smoothly to the teaching end point by the guide information during the teaching travel.

When creating a new teaching traveling route to replace an existing teaching traveling route or to add to an existing teaching traveling route, the difference calculator may calculate, before execution of the teaching travel mode, the difference in the position coordinates and the posture angle between a teaching start point of the new teaching traveling route as the arbitrary point and the current position, and calculate, during execution of the teaching travel mode, the difference in the position coordinates and the posture angle between a teaching end point of the new teaching traveling route as the arbitrary point and the current position.

For example, in a preferred embodiment where multiple teaching traveling routes are connected, a new teaching traveling route may be created to replace a teaching traveling route in the middle. In that case, with this autonomous vehicle, the operator can move the autonomous vehicle smoothly to the teaching start point by the guide information before executing the teaching travel, and move the autonomous vehicle smoothly to the teaching end point by the guide information during the teaching travel.

With the autonomous vehicles according to preferred embodiments of the present invention, the operator can create a desired straight route or circular route accurately.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic plan view of a driving range.

FIG. 2 is a schematic perspective view of a ball collecting/ejecting machine.

FIG. 3 is a schematic perspective view of the ball collecting/ejecting machine.

FIG. 4 is a block diagram showing an overall configuration of a controller.

FIG. 5 is a flowchart showing a control operation of a manual operation teaching mode for fill travel.

FIG. 6 is a flowchart showing the details of a step to create a ball collection route travel schedule.

FIG. 7 is a schematic view showing in a stepwise manner how a ball collection route is created in a traveling area.

FIG. 8 is a schematic view showing in a stepwise manner how a ball collection route is created in a traveling area.

FIG. 9 is a schematic view showing in a stepwise manner how a ball collection route is created in a traveling area.

FIG. 10 is a schematic view showing in a stepwise manner how a ball collection route is created in a traveling area.

FIG. 11 is a flowchart showing an operation of a difference calculator and a display when a teaching travel mode is executed.

FIG. 12 is a diagram showing a display state of the display.

FIG. 13 is a diagram showing a display state of the display.

FIG. 14 is a diagram showing a display state of the display.

FIG. 15 is a flowchart showing a guidance operation to an autonomous travel start position before execution of an autonomous travel mode.

FIG. 16 is a diagram showing a display state of the display.

FIG. 17 is a diagram showing a display state of the display.

FIG. 18 is a schematic view showing continuous operations of copy teaching travel, fill teaching (outer circumference) travel, copy teaching travel, fill teaching (outer circumference) travel, and copy teaching travel as a teaching travel of a second preferred embodiment of the present invention.

FIG. 19 is a schematic diagram showing continuous operations of copy travel, fill travel, copy travel, fill travel, and copy travel as a teaching reproduction travel of the second preferred embodiment of the present invention.

FIG. 20 is a schematic view showing continuous operations of copy teaching travel, copy teaching travel, and copy teaching travel, and a new copy teaching travel for replacement.

FIG. 21 is a diagram showing the difference in the position coordinates and the posture angle between a travel destination point and the current position during a copy teaching travel on a display.

### DETAILED DESCRIPTION OF THE PREFERRED EMBODIMENTS

Hereinafter, ball collecting/ejecting machines will be described as example of autonomous vehicles. However, preferred embodiments of the present invention are not limited to ball collecting/ejecting machines, and can be applied to cleaning machines or travel devices of amusement park rides, for example.

### First Preferred Embodiment

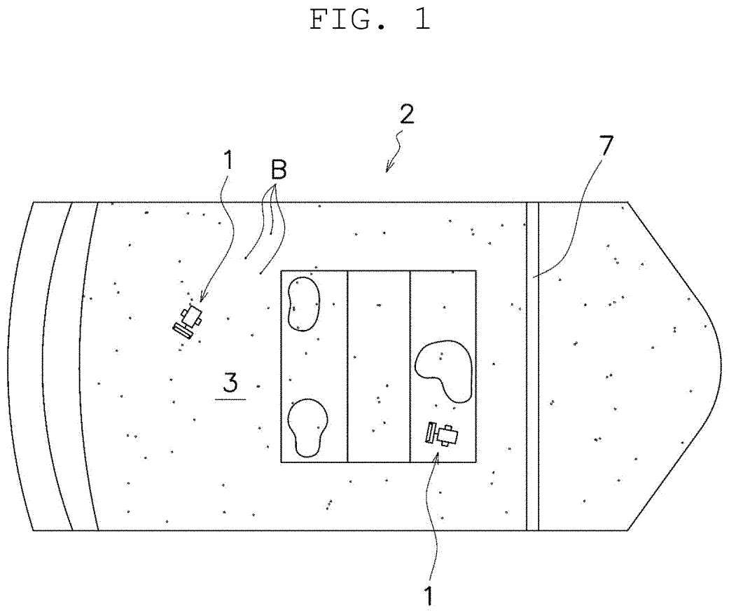

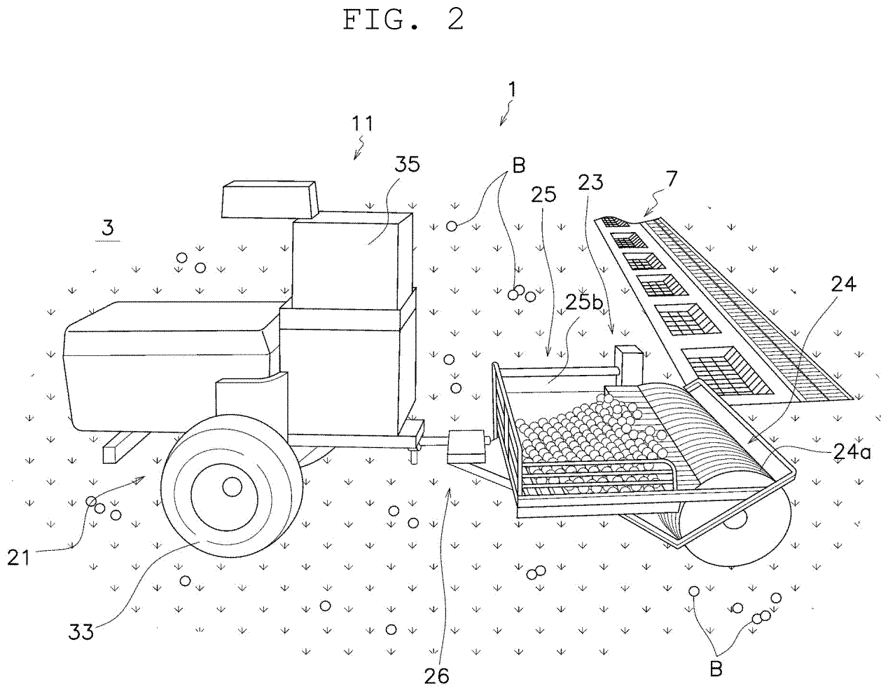

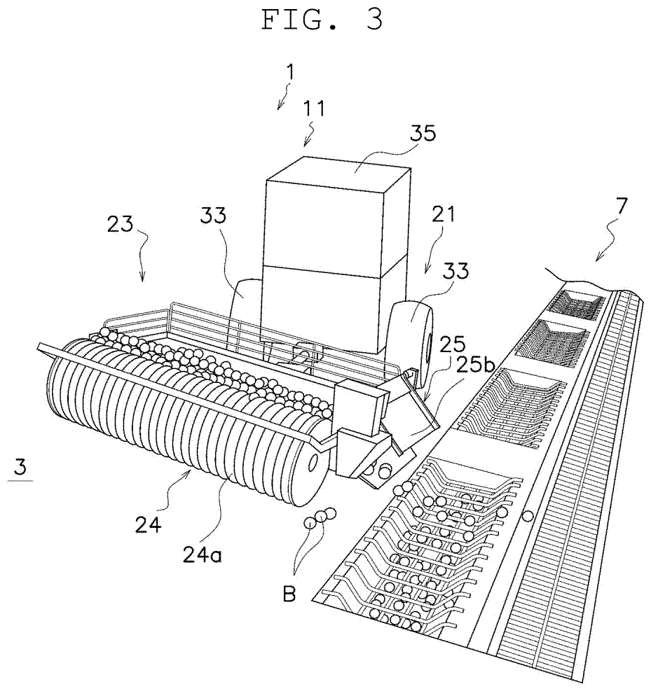

A ball collecting/ejecting machine 1 (an example of an autonomous vehicle) will be described with reference to FIGS. 1 to 3. FIG. 1 is a schematic plan view of a driving range. FIGS. 2 and 3 are schematic perspective views of the ball collecting/ejecting machine.

In the present preferred embodiment, the ball collecting/ejecting machine 1 is preferably used in a driving range 2. At the driving range 2, many golf balls B are scattered in a short time, so it is necessary to collect and reuse them.

The driving range 2 has a ball scattering area 3 in which multiple golf balls B are scattered, and a ball ejection place 7 in which the collected golf balls B are discharged. In this preferred embodiment, grass is planted in the ball scattering area 3. The ball ejection place 7 is a groove provided in the ball scattering area 3. Golf balls B ejected to the ball ejection place 7 are sent to a collection pool (not illustrated) by discharged water.

The ball collecting/ejecting machine 1 is a device that collects and ejects balls by performing teaching reproduction travel in the driving range 2. “Teaching reproduction travel” is travel based on a route taught by the operator in advance, and includes, for example, copy travel in which the very traveling route taught by the operator in advance is traveled, and fill travel in which a controller determines an autonomous travel route within a frame taught by the operator in advance.

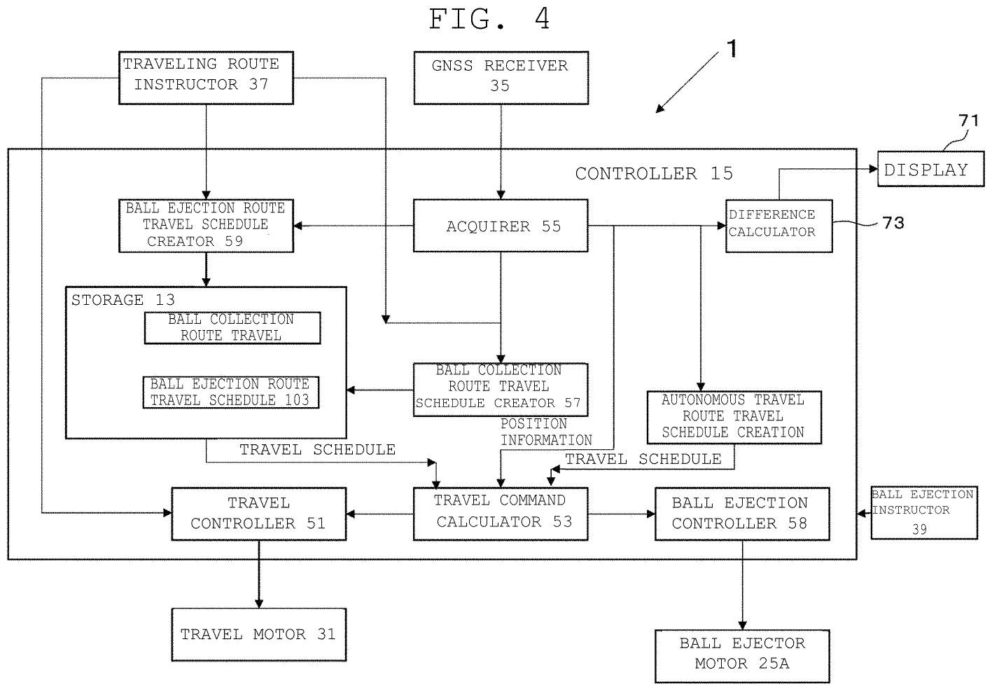

The ball collecting/ejecting machine 1 includes a main body 11, a storage 13 (FIG. 4), and a controller 15 (FIG. 4).

The main body 11 has a traveler 21 and a ball collector/ejector 23 capable of collecting the golf balls B and ejecting the golf balls B. Specifically, the traveler 21 is a device that enables the ball collecting/ejecting machine 1 to travel. The traveler 21 includes, for example, a travel motor 31 (FIG. 4) provided on the main body 11 and wheels 33.

The ball collecting/ejecting machine 1 includes a global navigation satellite system (GNSS) receiver 35 provided in the main body 11. The GNSS receiver 35 acquires information (position information) regarding the current position of the ball collecting/ejecting machine 1 on the ground. With this configuration, the ball collecting/ejecting machine 1 can travel outdoors while determining its own position.

The ball collecting/ejecting machine 1 may include a geomagnetic sensor (not illustrated) provided in the main body 11. A geomagnetic sensor measures the direction of the geomagnetism at the position of the ball collecting/ejecting machine 1 in the driving range 2. With this configuration, it is possible to measure the direction in which the ball collecting/ejecting machine 1 is facing in the driving range 2.

In addition, a pair of GNSS receivers 35 may be provided on the main body 11. For example, a pair of GNSS receivers 35 are arranged side by side on a predetermined axis of the main body 11 (e.g., an axis parallel or substantially parallel to the straightforward direction of the ball collecting/ejecting machine 1). With this configuration, the orientation (direction) of the main body 11 in the driving range 2 can be calculated from two coordinate values (combination of latitude and longitude) obtained from the pair of GNSS receivers 35 (moving baseline method). As a result, by calculating the direction using the coordinates obtained by the GNSS receivers 35, the direction of the ball collecting/ejecting machine 1 can be measured (calculated) easily without performing calibration for each service place where is required for accurate use of the geomagnetic sensor.

The ball collector/ejector 23 includes a ball collector 24 to collect the golf balls B and a ball ejector 25 to eject the golf balls B. The ball collector 24 uses a known technique, and includes a pickup rotor 24a that rotates together with traveling of the main body 11. Note that the ball collector 24 may be configured such that the pickup rotor 24a is rotated by a ball collector motor (not illustrated). The ball ejector 25 uses a known technique, and includes a ball ejector motor 25a (FIG. 4) and a ball ejection gate 25b driven by the ball ejector motor 25a.

The ball collector/ejector 23 is connected to the traveler 21 by a traction structure 26.

The storage 13 is provided in the controller 15 in this preferred embodiment. The storage 13 is a portion or all of a storage area of a storage device (i.e., memory) of a computer system including the controller 15, and stores various information related to the ball collecting/ejecting machine 1. The storage 13 stores, for example, a ball collection route travel schedule 101 and a ball ejection route travel schedule 103, as will be described later.

The controller 15 is a computer system including a CPU, a storage device (RAM, ROM, hard disk drive, SSD, and the like), various interfaces, and the like. The controller 15 performs various control related to the ball collecting/ejecting machine 1.

The configuration of the controller 15 will be described in detail with reference to FIG. 4. FIG. 4 is a block diagram showing the overall configuration of the controller. Note that all or a part of each functional block of the controller 15 described below may be implemented by a program that can be executed by the computer system as the controller 15. In this case, the program may be stored in a memory and/or the storage device. All or part of each functional block of the controller 15 may be implemented as a custom IC such as an SoC (system on chip).

The controller 15 may be configured by one computer system or may be configured by multiple computer systems. When the controller 15 is configured by multiple computer systems, for example, the functions implemented by the multiple functional blocks of the controller 15 can be distributed to and executed by multiple computer systems at an arbitrary ratio.

The controller 15 is configured or programmed to include a travel controller 51. The travel controller 51 controls the travel motor 31. A travel command is input to the travel controller 51 from a travel command calculator 53 (to be described later). Additionally, during a teaching travel mode, a travel command is input to the travel controller 51 from a traveling route instructor 37. The traveling route instructor 37 is, for example, an operator of the ball collecting/ejecting machine 1 such as a steering wheel. That is, the operation of the operator by the traveling route instructor 37 is input to the travel controller 51.

The controller 15 is configured or programmed to include the travel command calculator 53. The travel command calculator 53 outputs a travel command to the travel controller 51. Data provided to the travel command calculator 53 is the ball collection route travel schedule 101 in a fill travel mode and the ball ejection route travel schedule 103 in a copy travel mode. The travel controller 51 calculates a target rotation speed of the travel motor 31, and outputs driving power to rotate the travel motor 31 at the target rotation speed to the travel motor 31.

The controller 15 includes a ball ejection controller 58. The ball ejection controller 58 controls the ball ejector motor 25a.

The controller 15 is configured or programmed to include a position acquirer 55 (an example of a current position estimator). The position acquirer 55 acquires the position information acquired by the GNSS receiver 35. As a result, the controller 15 can grasp which position in the ball scattering area 3 the ball collecting/ejecting machine 1 is moving. Specifically, the absolute coordinates (latitude/longitude) of the current position obtained by real time kinematic (RTK) positioning are input to the position acquirer 55.

The controller 15 is configured or programmed to include a ball collection route travel schedule creator 57 (an example of a planned traveling route creator). The ball collection route travel schedule creator 57 creates the above-mentioned ball collection route travel schedule 101. The ball collection route travel schedule 101 is a schedule in which the ball collecting/ejecting machine 1 travels a travel area TA evenly (as if to “fill”). The travel area TA is an area in which the ball collecting/ejecting machine 1 travels in the traveling environment.

The ball collection route travel schedule creator 57 receives position information input from the position acquirer 55 every predetermined time (e.g., every control cycle in the controller 15) during execution of a manual operation teaching mode. As a result, the ball collection route travel schedule creator 57 acquires the multiple pieces of position information in the form of a sequence of points, and determines the travel area TA based on this series of points.

Next, the ball collection route travel schedule creator 57 creates the ball collection route travel schedule 101 in the travel area TA and stores it in the storage 13.

The controller 15 is configured or programmed to include a ball ejection route travel schedule creator 59. The ball ejection route travel schedule creator 59 creates the ball ejection route travel schedule 103 on the basis of the rotation amount and/or the rotation direction of the steering wheel input from the traveling route instructor 37 during the teaching travel mode. The ball ejection route travel schedule 103 is a set of passing times and pieces of passing point data corresponding to the passing times in the teaching travel mode, and indicates a traveling route on which the ball collecting/ejecting machine 1 autonomously moves during execution of a reproduced travel mode. During execution of the reproduced travel mode, the ball collecting/ejecting machine 1 refers to a target position indicated in the ball ejection route travel schedule 103, and controls the travel motor 31 so that the ball collecting/ejecting machine 1 reaches the target position.

With the above configuration, as reproduced travel control, during execution of an autonomous travel mode, the travel command calculator 53 uses information stored in the ball collection route travel schedule 101 or the ball ejection route travel schedule 103 and position information acquired from the position acquirer 55 to calculate a control command (reproduced travel control command) for the ball collecting/ejecting machine 1 to travel autonomously on a traveling route shown in the above travel schedule, and outputs the control command to the travel controller 51.

As a result, during execution of the autonomous travel mode, the travel controller 51 enables the ball collecting/ejecting machine 1 to move autonomously by controlling the travel motor 31 on the basis of the reproduced travel control command.

The ball collecting/ejecting machine 1 is configured or programmed to include a ball ejection instructor 39. The ball ejection instructor 39 includes, for example, an operation panel including a push button and the like. The ball ejection instructor 39 transmits an operator's operation of the push button to the ball ejection controller 58, for example. The ball ejection controller 58 accepts a button operation from the ball ejection instructor 39, and converts the operation into a ball collection instruction or a ball ejection instruction. The ball ejection controller 58 outputs the ball ejection instruction to the ball ejector motor 25a to drive the ball ejection gate 25b.

A ball collection condition and a ball ejection condition are respectively stored in association with the ball collection route travel schedule 101 and the ball ejection route travel schedule 103 by the travel command calculator 53.

During execution of the autonomous travel mode, the ball ejection controller 58 controls the ball ejector motor 25a to open the ball ejection gate 25b on the basis of the ball ejection condition associated with the ball ejection route travel schedule 103. As a result, the ball collecting/ejecting machine 1 can collect balls and eject balls autonomously according to the ball ejection condition during autonomous travel.

The controller 15 is configured or programmed to include an autonomous travel route travel schedule creator 61.

If the start point and the end point can be obtained, the autonomous travel route travel schedule creator 61 calculates an optimum travel schedule and creates an autonomous travel route travel schedule based on the optimum travel schedule. Note that the route generation algorithm is known and is not particularly limited.

In the autonomous travel mode, the travel command calculator 53 transmits a travel command to the travel controller 51 on the basis of the above-mentioned autonomous travel route travel schedule.

Although not illustrated, the controller 15 is connected to sensors to detect the state of the devices, a switch, and an information input device.

For example, an encoder (not illustrated) is attached to an output rotation shaft of the travel motor 31. Moreover, a front detector and a rear detector (not illustrated) are attached to the main body 11. These are laser range finders (LRFs) with a detection range equal to or more than 180 degrees. The front detector and the rear detector may include time of flight (TOF) cameras or the like.

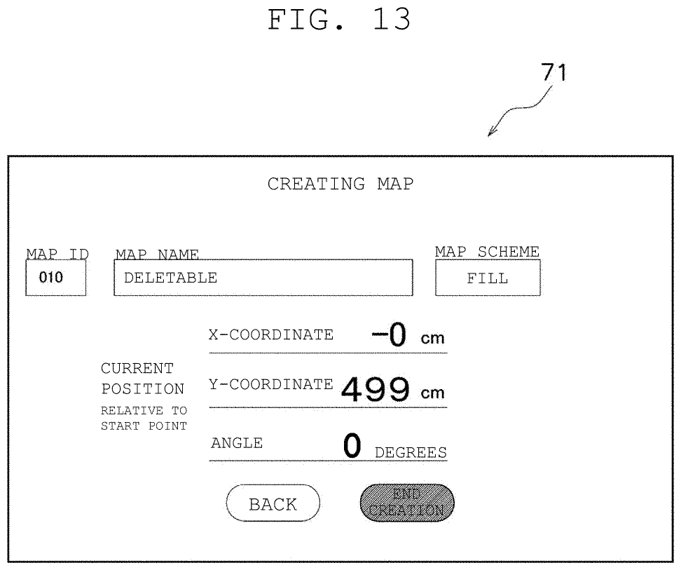

As shown in FIG. 4, the ball collecting/ejecting machine 1 also includes a display 71 (an example of a display) (also refer to FIGS. 12 to 14). The display 71 may be integrated with the main body 11 or may be a separate body. For example, the display 71 may be a display fixed to the main body 11, a portable display connected to the main body 11 by wire or wirelessly, or a portable display detachable from the main body 11.

The controller 15 is configured or programmed to include a difference calculator 73. The difference calculator 73 calculates the difference in the position coordinates and the posture angle of an arbitrary point designated by the operator and the current position. Specifically, the position coordinates and the posture angle at an arbitrary point designated by the operator are stored in the controller 15 or an external storage device. Then, the position coordinates and the posture angle of the current position are obtained from the position acquirer 55. Based on these pieces of data, the difference calculator 73 calculates the above difference. The above difference is displayed by the display (to be described later).

In this way, the operator can know the difference in the coordinates and posture of the ball collecting/ejecting machine 1 between the arbitrary point and the current position by looking at the display 71. Accordingly, for example, by displaying the distance and the angle from an arbitrary position designated by the operator during the time of manual operation, the operator can create a desired linear route or circular route accurately.

Moreover, also in teaching reproduction, the operator can refer to the position and angle of the ball collecting/ejecting machine 1 to enable straight travel and a 180 degree U-turn. Accordingly, a more efficient route can be created.

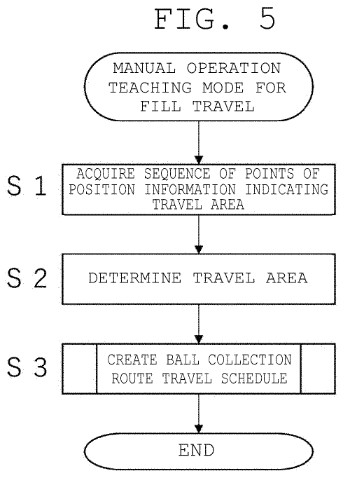

The manual operation teaching mode for fill travel will be described with reference to FIG. 5. FIG. 5 is a flowchart showing the control operation of the manual operation teaching mode for fill travel.

The flowchart described below is an example, and each step can be omitted or replaced as necessary. Additionally, multiple steps may be performed at the same time, or some or all of the steps may be performed in an overlapping manner.

Moreover, each block of the flowchart is not limited to a single control operation, and can be replaced with multiple control operations represented by multiple blocks.

Note that operations of the devices are the result of commands from the controller to the devices, and these are represented by steps of a software application.

In step S1, during execution of the manual operation teaching mode, the ball collection route travel schedule creator 57 acquires a sequence of points (coordinate value) of position information representing the travel area TA.

In step S2, the ball collection route travel schedule creator 57 determines the travel area TA. In step S3, the ball collection route travel schedule creator 57 creates the ball collection route travel schedule 101 including a filling route in the travel area TA, and stores the schedule in the storage 13.

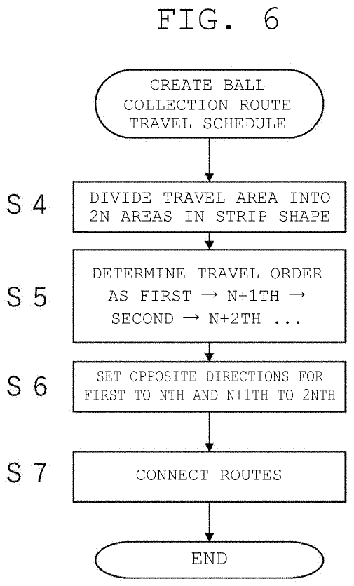

Step S3 of FIG. 5 will be described in detail with reference to FIGS. 6 to 10. FIG. 6 is a flowchart showing the details of the step to create the ball collection route travel schedule. FIGS. 7 to 10 are schematic views showing in a stepwise manner a how a ball collection route is created in a travel area. Note that there are multiple methods for creating a ball collection route, and the following description is only an example.

In step S4, as shown in FIG. 7, the ball collection route travel schedule creator 57 divides the area into 2N areas in a strip shape. At this time, the longitudinal direction of each area is the main direction, and a direction orthogonal to the main direction is the sub-direction. In this preferred embodiment, the width of the divided area is equal to or less than the width of the ball collector/ejector 23.

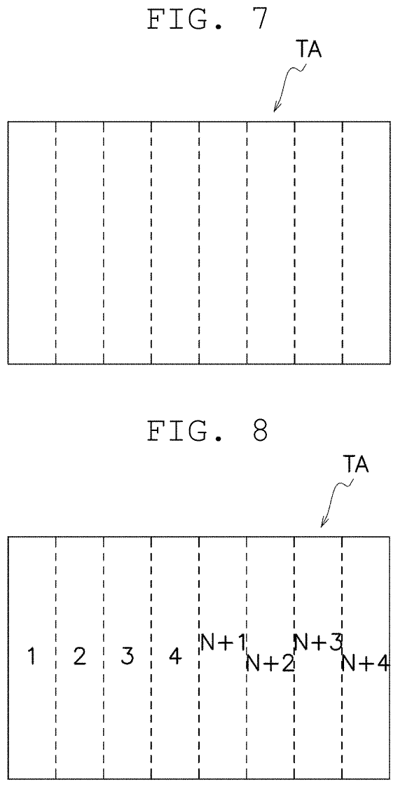

In step S5, as shown in FIG. 8, the ball collection route travel schedule creator 57 determines the travel order of the divided areas to be the first area, the N+1th area, the second area, the N+2th area, and so on.

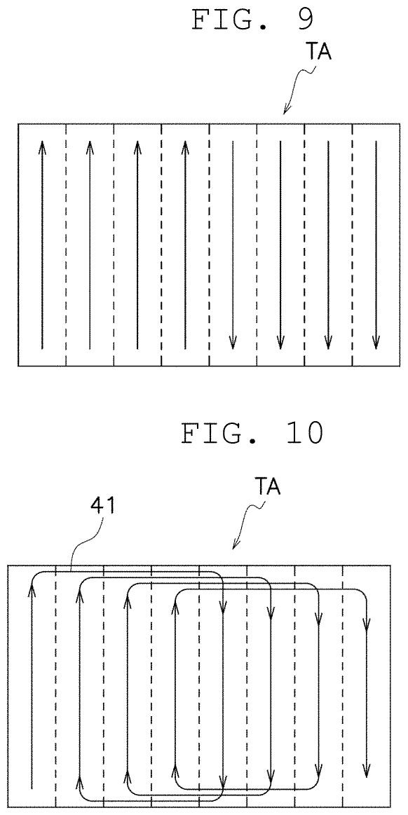

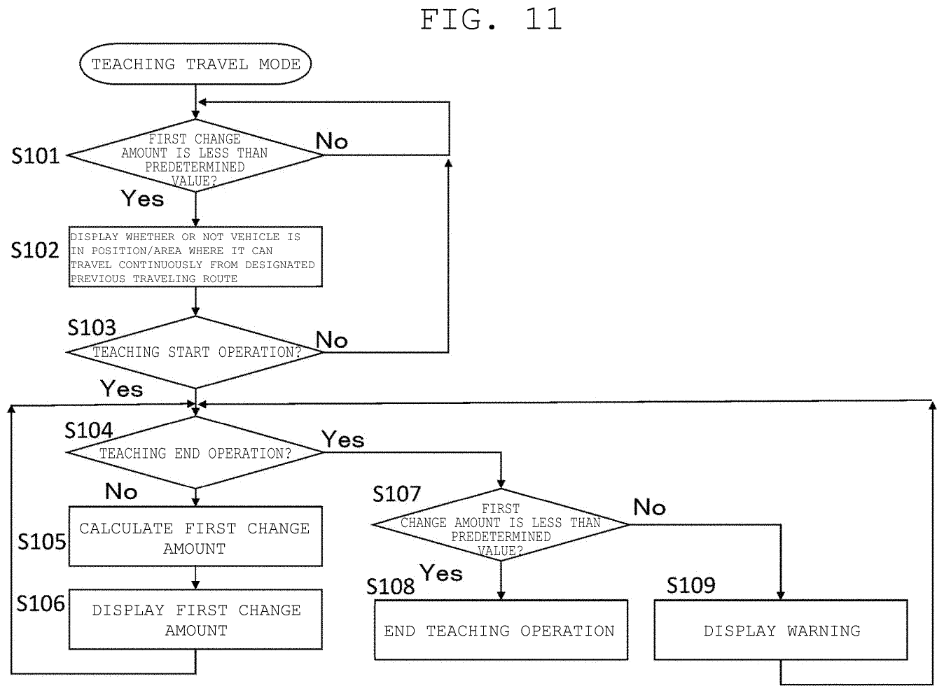

In step S6, as shown in FIG. 9, the ball collection route travel schedule creator 57 sets a traveling route in each of the 2N areas. In this case, the traveling direction in the first to Nth areas are opposite to the traveling direction in the N+1 to 2Nth areas. In step S7, the routes are connected as shown in FIG. 10. Specifically, the end point of the m(1, 2, . . . N−1)th traveling route and the start point of the m+Nth traveling route are connected, and the end point of the m+Nth traveling route and the start point of the m+1th traveling route are connected. This connecting operation is repeated by starting m from 1 and increasing it by 1 until it reaches N−1.

Moreover, the end point of the Nth traveling route and the start point of the 2Nth traveling route are connected, and then the end point of the 2Nth traveling route is connected to the start point of the first traveling route to end the creation of the traveling route.

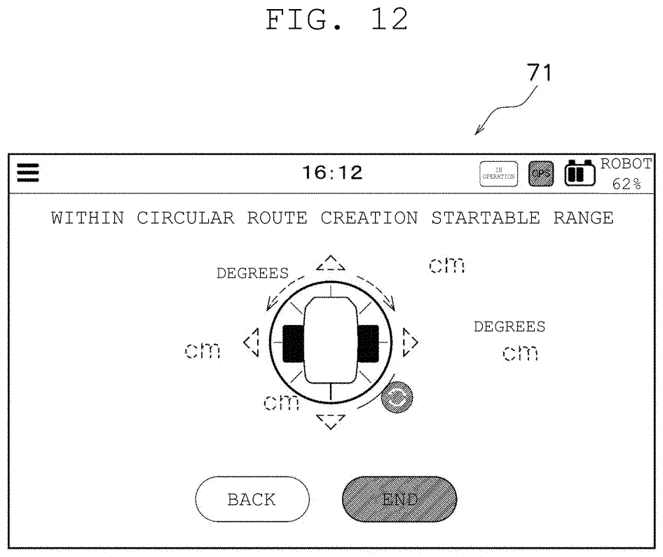

An example of the operation of the difference calculator and the display of information on the display 71 during execution of the teaching travel mode when teaching the outer circumference of the filling area will be described with reference to FIGS. 11 to 14. FIG. 11 is a flowchart showing the operation of the difference calculator and the display during execution of the teaching travel mode. FIGS. 12 to 14 are diagrams showing display states of the display.

In the following operation, the operator manually causes the ball collecting/ejecting machine 1 to travel to the start point of the teaching travel mode when teaching the outer circumference of the filling area.

In step S101 of FIG. 11, the difference calculator 73 calculates the “change amount of the position coordinates and the posture angle from the teaching start point to the current position” (hereinafter referred to as “first change amount”). That is, the position coordinates and posture angle of the teaching start point are compared with those of the current position during execution of the teaching travel mode. Then, it is determined whether or not the first change amount is less than a predetermined value.

If the first change amount is equal to or more than the predetermined value, the processing repeats step S101. This means that the ball collecting/ejecting machine 1 has not reached the teaching start point (an area where teaching can be started).

If the first change amount is less than a predetermined value, the processing proceeds to step S102. This means that the ball collecting/ejecting machine 1 has reached the teaching start point.

In step S102, as shown in FIG. 12, the display 71 displays whether or not the vehicle is in a position/area where the vehicle can continuously travel from a designated previous traveling route. Specifically, in FIG. 12, “Within circular route creation startable range” is displayed. Accordingly, the operator can surely know the above information. The above display is performed by an operator's display operation or automatically, for example. That is, step S102 may be performed by the operator on the basis of a teaching start preparation operation, or may be performed automatically.

In step S103, it is determined whether or not a teaching operation start operation has been performed within a predetermined time, for example. If the above operation is not performed, the processing returns to step S101. That is, until the teaching operation start operation is performed, it is continuously displayed that a circular path can be created while the ball collecting/ejecting machine 1 is at the teaching start point. If the above operation is performed, the processing proceeds to step S104. Note that after this, the teaching operation is executed.

In step S104, it is determined whether or not a teaching end operation has been performed. If the above operation has not been performed, the processing proceeds to step S105. If the above operation has been performed, the processing proceeds to step S107.

In step S105, the first change amount is calculated. Specifically, the difference calculator 73 calculates the change amount of the position coordinates and the posture angle from the teaching start point to the current position.

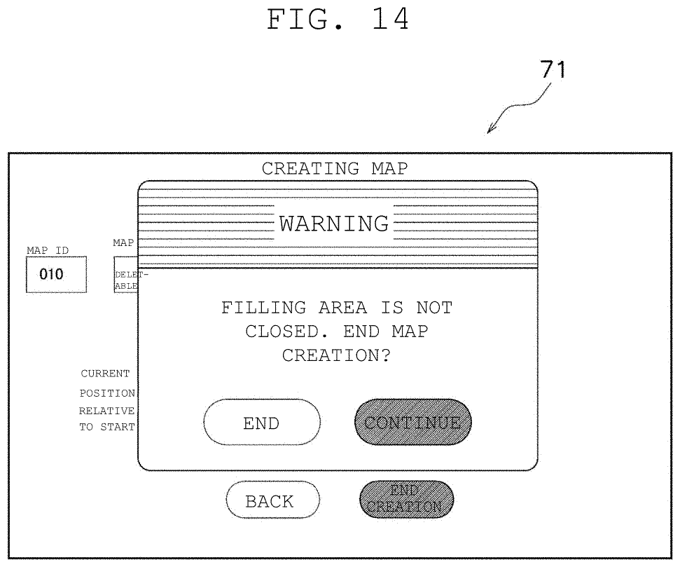

In step S106, as shown in FIG. 13, the first change amount is displayed on the display 71 during execution of the teaching travel mode. Specifically, the values of the X-coordinate, the Y-coordinate, and the angle relative to the teaching start point are displayed. Accordingly, it becomes easy to create an outer circumference route for filling having a closed outer circumference and a rectangular outer circumference route for filling. After step S106, the processing returns to step S104.

In step S107, it is determined whether or not the first change amount is less than a predetermined value. If the first change amount is less than the predetermined value, the processing proceeds to step S108. This means that the ball collecting/ejecting machine 1 has returned to the teaching start position. Note that if the first change amount exceeds the predetermined value, the processing proceeds to step S109. Note that the above determination is made on the basis of “position coordinates from the current position to an autonomous travel start point”.

In step S108, the teaching operation ends.

In step S109, as shown in FIG. 14, the display 71 displays warning information such as “Filling area is not closed. End map creation?” Accordingly, it is possible to prevent the operator from ending the teaching when the ball collecting/ejecting machine 1 has not returned to the teaching start point. After step S109, the processing returns to step S104.

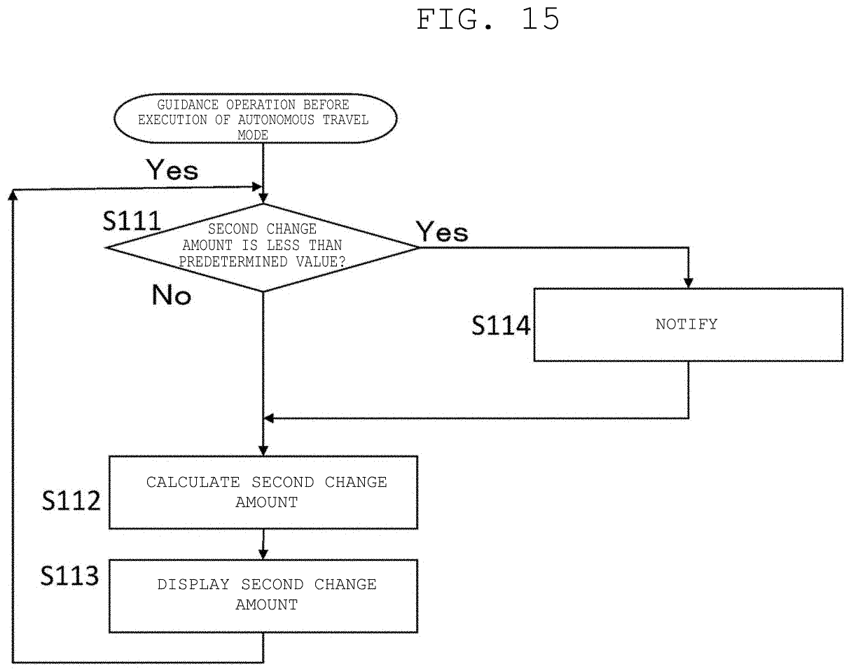

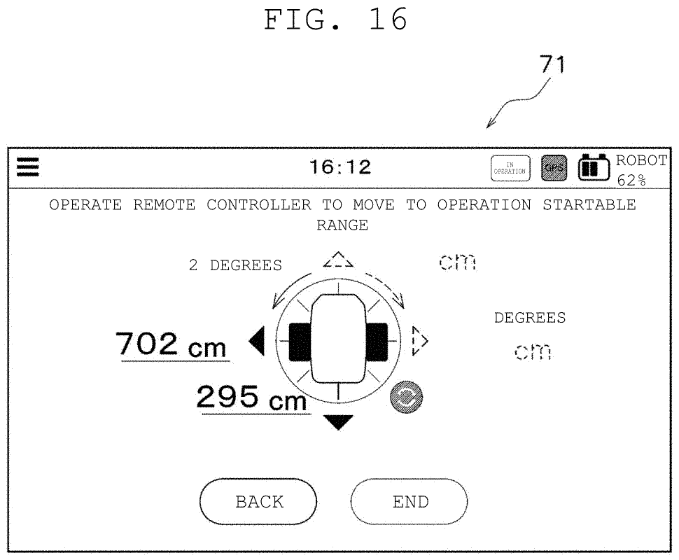

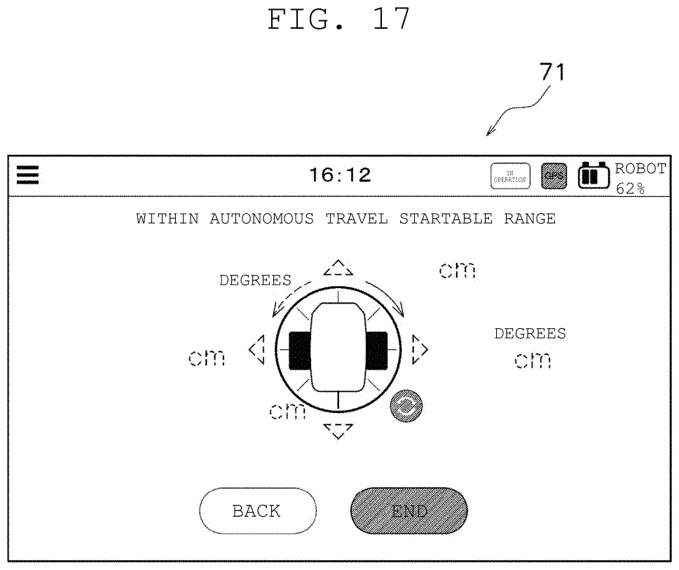

A method of guiding to an autonomous travel start position before execution of the autonomous travel mode will be described with reference to FIGS. 15 to 17. FIG. 15 is a flowchart showing a guidance operation to the autonomous travel start position before execution of the autonomous travel mode. FIGS. 16 and 17 are diagrams showing display states of the display.

In step S111 of FIG. 15, the difference calculator 73 calculates, as the difference, the “change amount of the position coordinates and the posture angle from the current position to the autonomous travel start point (i.e., a travel destination point)” (hereinafter referred to as “second change amount”).

In step S112, it is determined whether or not the second change amount is less than a predetermined value. If the second change amount is not less than the predetermined value, the processing proceeds to step S113. This means that the ball collecting/ejecting machine 1 has not reached the autonomous travel start point (an area where autonomous travel can be started). If the second change amount is less than the predetermined value, the processing proceeds to step S114. This means that the ball collecting/ejecting machine 1 has reached the autonomous travel start point.

In step S113, the display 71 displays the second change amount as shown in FIG. 16. Specifically, information on the X-coordinate, the Y-coordinate, and the angle relative to the autonomous travel start point is displayed. Accordingly, the operator can accurately know how the ball collecting/ejecting machine 1 deviates from the autonomous travel start point at the start of the autonomous travel. As a result, the operator can smoothly set the ball collecting/ejecting machine 1 to the autonomous travel start point when adjusting the position manually. Thereafter, the processing returns to step S111.

In step S114, the display 71 displays a notification that autonomous driving can be started, as shown in FIG. 17. Accordingly, the operator can quickly know that the ball collecting/ejecting machine 1 has reached the autonomous travel start point when adjusting the position manually. Thereafter, the processing proceeds to step S112.

Note that the autonomous travel start point may be in a filling area inside a fill travel area.

### Second Preferred Embodiment

In the first preferred embodiment, guide information is displayed on the display during travel to the teaching travel start point before the fill teaching travel and during travel to the teaching travel start point (=teaching travel end point) during the fill teaching travel. Additionally, in the first preferred embodiment, guide information is displayed during travel to the autonomous travel start point before the autonomous travel.

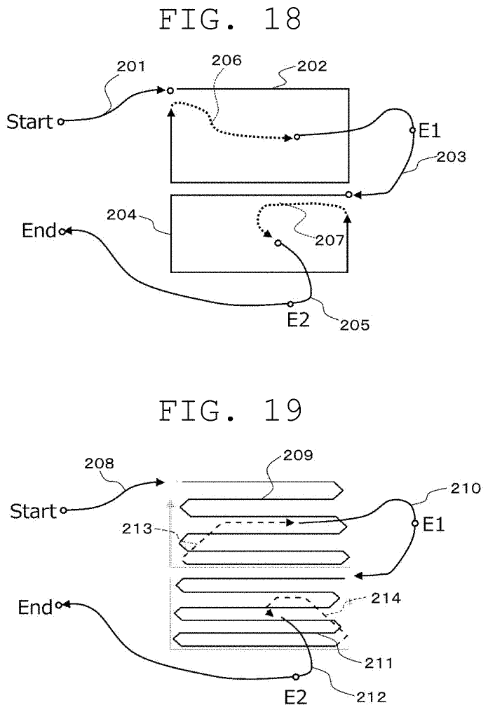

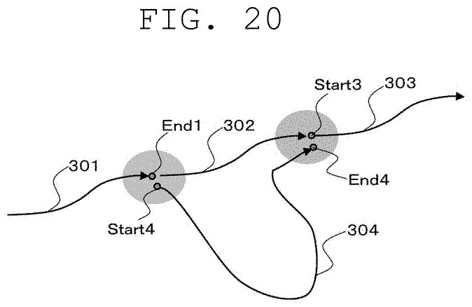

The display of guide information is also applicable to other types of teaching travels. A second preferred embodiment of the present invention will be described as such an example with reference to FIGS. 18 and 19.

FIG. 18 is a schematic view showing continuous operations of copy teaching travel, fill teaching (outer circumference) travel, copy teaching travel, fill teaching (outer circumference) travel, and copy teaching travel as a teaching travel of the second preferred embodiment. FIG. 19 is a schematic view showing continuous operations of copy travel, fill travel, copy travel, fill travel, and copy travel as a teaching reproduction travel of the second preferred embodiment.

A technique is known in which multiple traveling routes (maps) are combined to make an autonomous vehicle travel continuously on multiple routes. In this case, each traveling route is to be connected to the front and rear routes. Here, “connected” means that the end point and the start point are spatially coincident, or that the end point and the start point are within the application area of processing for connecting the traveling routes.

In the example shown in FIG. 18, from a start point “Start” to an end point “End”, a first copy teaching traveling route 201, a first fill teaching traveling route 202, a second copy teaching traveling route 203, a second fill teaching traveling route 204, and a third copy teaching traveling route 205 are combined. Note that the second copy teaching traveling route 203 includes a first ball ejection point E1, and the third copy teaching traveling route 205 includes a second ball ejection point E2. Note that a manual travel 206 is performed from the travel end point of the first fill teaching traveling route 202 to the travel start point of the second copy teaching traveling route 203, and a manual travel 207 is performed from the travel end point of the second fill teaching traveling route 204 to the travel start point of the third copy teaching traveling route 205.

As a result of the above, as shown in FIG. 19, a copy travel 208 from the start point “Start” to the start point of a fill travel 209, ball collection by the fill travel 209, ball ejection by a copy travel 210, ball collection by a fill travel 211, and ball ejection by a copy travel 212 are performed continuously. As a result, the burden on the operator is reduced. Note that an autonomous travel 213 is performed between the fill travel 209 and the copy travel 210, and an autonomous travel 214 is performed between the fill travel 211 and the copy travel 212.

Note that when connecting a copy traveling route to a fill traveling route, it is required that the start point of the copy traveling route is within a route generation possible range within the filling area inside the fill teaching travel area. Note that a “route generation possible range” is a range in which a route can be generated when the ball collecting/ejecting machine 1 travels autonomously from the end point of the fill travel.

In FIG. 18, during the first fill teaching traveling route 202→the second copy teaching traveling route 203→the second fill teaching traveling route 204→the third copy teaching traveling route 205, guide information is displayed during the manual travels 206 and 207 in between.

During the first copy teaching traveling route 201→the first fill teaching traveling route 202→the second copy teaching traveling route 203→the second fill teaching traveling route 204, since the end point of the earlier copy teaching traveling route and the start point of the later teaching travel are the same, guide information does not have to be displayed during the earlier teaching travel.

Note that when connecting a copy traveling route to a copy traveling route, it is required that the end point of the earlier copy traveling route is near the start point of the later copy traveling route, specifically, that the difference in distance and posture at the start point are within a certain range. In this case, too, since the end point of the earlier copy teaching traveling route and the start point of the later teaching travel coincide with each other, the guide information does not have to be displayed during the earlier teaching travel.

On the other hand, there may be a request to replace a portion of a continuous traveling route due to a layout change, a rut countermeasure, or the like. In this case, it is preferable to arrange the autonomous vehicle at the start point of the traveling route to be replaced (a point connected to the end position of the earlier traveling route). Then, in order to confirm the point, it is preferable to confirm by actually making the autonomous vehicle travel autonomously along a series of continuous traveling routes up to immediately before the traveling route to be replaced. That is, it takes time and effort for teaching. From the above, it is advantageous to pay attention to continuity when teaching a travel assuming that multiple travels are combined for continuous travel.

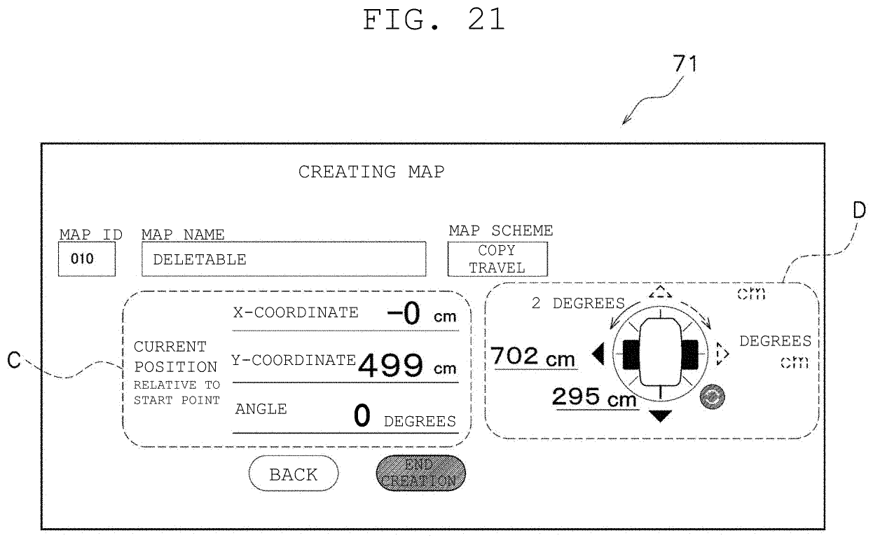

The replacement of a teaching traveling route, specifically, a copy teaching traveling route, will be described with reference to FIGS. 20 and 21. FIG. 20 is a schematic view showing continuous operations of copy teaching travel, copy teaching travel, and copy teaching travel, and a new copy teaching travel for replacement. FIG. 21 is a diagram showing the difference in the position coordinates and the posture angle between a travel destination point and the current position during a copy teaching travel on a display. In FIG. 20, a route connecting a first copy teaching traveling route 301→a second copy teaching traveling route 302→a third copy teaching traveling route 303 has already been created.

Here, it is assumed that the second copy teaching traveling route 302 is to be replaced with a new fourth copy teaching traveling route 304 for movement of an obstacle, for example.

In this case, it is necessary to match the following two points.

1) Align a start point “Start4” of the fourth copy teaching traveling route 304 with an end point “End1” of the first copy teaching traveling route 301.

In this case, before the copy teaching travel (i.e., until reaching the start point “Start4”), a display 71 displays the difference in the position coordinates and the posture angle between the start point “Start4” of the fourth copy teaching traveling route 304 and the current position. Accordingly, the operator can easily make a ball collecting/ejecting machine 1 travel to the end point “End1” by manual travel.

2) Align an end point “End4” of the fourth copy teaching traveling route 304 with a start point “Start3” of the third copy teaching traveling route 303.

The guide display displayed on the display 71 in this case is shown in FIG. 21. During the copy teaching travel, in addition to information C of the difference in the position coordinates and the posture angle between the start point “Start4” of the fourth copy teaching traveling route 304 and the current position, information D of the difference in the position coordinates and the posture angle between the current position and the start point “Start3” of the third copy teaching traveling route 303 (i.e., the point which is the end point “End4” of the fourth copy teaching traveling route 304) is displayed. Specifically, the information D includes the X-coordinate, the Y-coordinate, and the angle relative to the start point “Start3” of the third copy teaching traveling route 303. Accordingly, the operator can accurately know how the ball collecting/ejecting machine 1 deviates from the start point “Start3” of the third copy teaching traveling route 303 during the copy teaching travel. As a result, the operator can make the ball collecting/ejecting machine 1 travel smoothly to the start point “Start3” of the third copy teaching traveling route 303 when adjusting the position manually.

Note that the guide display during the teaching travel is particularly important in the case of copy teaching travel. This is because in the case of fill teaching travel, the vehicle returns to the original position (the end point is specified).

Additionally, the guide information up to the end point during copy teaching travel can also be displayed during normal copy teaching travel.

The first preferred embodiment can also be described as follows.

A ball collecting/ejecting machine 1 (an example of an autonomous vehicle) executes a teaching travel mode to store a route traveled by an operator's manual operation and an autonomous travel mode to autonomously travel on a planned traveling route. The ball collecting/ejecting machine 1 includes a ball collection route travel schedule creator 57, a position acquirer 55, a difference calculator 73, and a display 71.

The ball collection route travel schedule creator 57 (an example of a planned traveling route creator) creates a planned traveling route from the teaching route obtained by the teaching travel mode.

The position acquirer 55 (an example of a current position estimator) estimates the current position of the ball collecting/ejecting machine 1.

The difference calculator 73 (an example of a difference calculator) calculates the difference in the position coordinates and the posture angle between an arbitrary point designated by the operator and the current position.

The display 71 displays the above difference (see FIG. 13).

With this device, the operator can know the difference in the coordinates and posture angle of the ball collecting/ejecting machine 1 between the arbitrary point and the current position. Accordingly, for example, by displaying the distance and the angle from an arbitrary position designated by the operator during the time of manual operation, the operator can create a desired linear route or circular route accurately.

### Other Preferred Embodiments

As mentioned above, while multiple preferred embodiments of the present invention have been described, the present invention is not limited to the above preferred embodiments, and various changes can be made without departing from the gist of the present invention. In particular, the multiple preferred embodiments and alternative preferred embodiments described in the present specification can be arbitrarily combined as needed.

Preferred embodiments of the present invention are not limited to the ball collecting/ejecting machines as long as the preferred embodiments are autonomous vehicles. Preferred embodiments of the present invention can also be applied to a cleaning machine or a travel device of an amusement park ride, for example.

The difference may be displayed as a direction (east, west, north, south) or an orientation relative to the direction.

In the first preferred embodiment, the technique of confirming the teaching start point (i.e., confirming that the vehicle is within a range where a map can be created) has been used in the example of fill teaching travel→copy teaching travel. However, the above technique is also applicable to an example of copy teaching travel→copy teaching travel and an example of copy teaching travel→fill teaching travel.

In the second preferred embodiment, the replacement of a copy teaching traveling route has been described. However, the same technique is applicable to the replacement of a fill teaching outer circumference route. Additionally, the technique of the second preferred embodiment is also applicable to a case of creating a new teaching traveling route to add to an existing teaching traveling route.

Preferred embodiments of the present invention can be widely applied to autonomous vehicles.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An autonomous vehicle that executes a teaching travel mode to store a route traveled by an operator's manual operation and an autonomous travel mode to autonomously travel on a planned traveling route, the autonomous vehicle comprising:
a planned traveling route creator to create a planned traveling route from a teaching route obtained by the teaching travel mode;
a current position estimator to estimate a current position of the autonomous vehicle;
a difference calculator to calculate differences in position coordinates and posture angles between an arbitrary point and the current position; and
a display to display the differences as guide information.

2. The autonomous vehicle according to claim 1, wherein
the arbitrary point is a teaching start point of the teaching travel mode; and
the difference calculator calculates, as the differences, a change amount of the position coordinates and the posture angle from the teaching start point to the current position during execution of the teaching travel mode.

3. The autonomous vehicle according to claim 2, wherein when the change amount of the position coordinates and the posture angles from the teaching start point to the current position falls below a predetermined value during execution of the teaching travel mode when teaching an outer circumference of a filling area, the display displays that an annular route is able to be created.

4. The autonomous vehicle according to claim 2, wherein when the change amount of the position coordinates and the posture angles from the teaching start point to the current position does not fall below a predetermined value at the end of the teaching during execution of the teaching travel mode when teaching an outer circumference of a filling area, the display displays warning information.

5. The autonomous vehicle according to claim 1, wherein
the arbitrary point is an autonomous travel start point; and
the difference calculator calculates the differences in the position coordinates and the posture angles between the current position and the autonomous travel start point before the autonomous travel.

6. The autonomous vehicle according to claim 5, wherein the display displays a notification that autonomous travel is able to be started when the differences in the position coordinates and the posture angles between the current position and the autonomous travel start point fall below a predetermined value.

7. The autonomous vehicle according to claim 1, wherein
the arbitrary point is a teaching end point of the teaching travel mode; and
the difference calculator calculates the differences in the position coordinates and the posture angles between the teaching end point and the current position during execution of the teaching travel mode.

8. The autonomous vehicle according to claim 1, wherein when creating a new teaching traveling route to replace an existing teaching traveling route or to add to an existing teaching traveling route, the difference calculator calculates, before execution of the teaching travel mode, the differences in the position coordinates and the posture angles between a teaching start point of the new teaching traveling route as the arbitrary point and the current position, and calculates, during execution of the teaching travel mode, the differences in the position coordinates and the posture angles between a teaching end point of the new teaching traveling route as the arbitrary point and the current position.
